(19) United States
(12) Patent Application Publication
(10) Pub. No.: US 2025/0376359 A1
(43) Pub. Date: Dec. 11, 2025

(54) Container Transport System

(71) Applicant: Daifuku Co., Ltd., Osaka-shi (JP)

(72) Inventor: Takashi Ukon, Osaka-shi (JP)

(21) Appl. No.: 19/227,951

(22) Filed: Jun. 4, 2025

(30) Foreign Application Priority Data
Jun. 5, 2024 (JP) 2024-091709

(51) Int. Cl. B66F 9/06; B31B 50/00; B65B 5/04; B65B 43/54; B65G 1/137; B66F 9/065

(52) U.S. Cl. CPC B66F 9/063; B31B 50/006; B65B 5/04; B65B 43/54; B66F 9/065; B65G 1/1378

(57) ABSTRACT

An empty container transport system includes a plurality of transport vehicles that travel in a travel area, an empty container supplier that supplies a plurality of empty containers of different types selectively to the respective plurality of transport vehicles, a plurality of work stations, and a controller. The controller generates, based on container request information including at least a type of empty container to be used at each of the plurality of work stations, empty container supply information to supply an empty container to each of the plurality of work stations. Each of the plurality of transport vehicles holds the empty container of the type corresponding to the container request information and transports the empty container to the corresponding work station based on the empty container supply information.

### CROSS-REFERENCE TO RELATED APPLICATION

This application claims priority to Japanese Patent Application No. 2024-091709 filed Jun. 5, 2024, the disclosure of which is hereby incorporated by reference in its entirety.

### BACKGROUND OF THE INVENTION

### Field of the Invention

The present invention relates to a container transport system for transporting empty containers.

### Description of Related Art

In delivering articles ordered through, for example, mail-order systems, the articles are collected based on orders and packed into containers for delivery in a shipping operation. Such articles are packed into appropriate containers based on, for example, the size and the number of articles. The shipping operation performed at a work station uses containers with different capacities. A picking facility (10) described in Japanese Patent No. 5338692 includes a picking area (11) for picking articles to be shipped and an inspection-packing area (13) for packing the picked articles into containers (packing boxes (23)) (reference signs in parentheses in the background are the reference signs in the cited literature). In the picking area (11), an operator collects articles based on the order and packs the articles into an empty picking container (22). The picking container (22) containing all the articles to be shipped is transported to a packing-box supply area (12) with a transport line (26) including a conveyor. The packing-box supply area (12) includes a packing-box storage shelf (51) storing packing boxes (23) with different volumes. In the packing-box supply area (12), an operator different from the operator in the picking area (11) selects a packing box (23) based on the order and supplies the packing box (23) to the picking container (22). The picking container (22) containing the articles based on the order and the packing box (23) is transported to the inspection-packing area (13) with the transport line (26). In the inspection-packing area (13), still another operator performs a packing operation of packing the items into the packing box (23).

In the picking facility described above, multiple packing boxes (containers) are stored in a single packing-box storage shelf and sequentially supplied to the picking container from the shelf. Although the stored packing boxes are consumed, the above literature does not describe restocking of the packing boxes for the packing-box storage shelf. When packing boxes with a specific volume are in high demand and result in shortage of the packing boxes, for example, the operations in the packing-box supply area and subsequent areas may be delayed.

A picking system described in Japanese Unexamined Patent Application Publication No. 10-297721 includes picking stations (9) on which operators place empty cardboard boxes (8) and pack the picked articles. The picking stations (9) are aligned in the transport direction of a packed-box conveyor (12) for transporting packed cardboard boxes (11). Each picking station (9) receives an empty cardboard box (8) from an empty-box conveyor (10) disposed along the packed-box conveyor (12). In other words, the empty cardboard boxes (8) are transported in series along the picking stations (9).

When empty cardboard boxes of different types (e.g., volumes and sizes) are used, an empty cardboard box of the requested type may not be supplied at appropriate timing in the system including the multiple picking stations to which the empty cardboard boxes are transported sequentially in series as described above. When an operator working at an upstream picking station picks an empty cardboard box, an operator working downstream may fail to receive an empty cardboard box of the requested type.

### SUMMARY OF THE INVENTION

In response to the above, techniques are awaited for supplying empty containers of appropriate types at appropriate timing to a location at which an operation is performed using the empty containers.

A container transport system in response to the above includes a plurality of transport vehicles that travel in a travel area, an empty container supplier that supplies a plurality of empty containers of different types selectively to the respective plurality of transport vehicles, a plurality of work stations facing the travel area and being a work station in which an operation using an empty container is performed, and a controller that generates, based on container request information including at least a type of empty container to be used at each of the plurality of work stations, empty container supply information to supply an empty container to each of the plurality of work stations. Each of the plurality of transport vehicles holds the empty container of the type corresponding to the container request information and transports the empty container to the work station corresponding to the container request information based on the empty container supply information.

In this structure, multiple transport vehicles traveling in the travel area transport empty containers, achieving higher flexibility in selecting the transport path for the empty containers than when the empty containers are transported by, for example, a conveyor. This structure can thus reduce unequal transport time of empty containers to the respective work stations resulting from the arrangement of the multiple work stations, and allows the empty containers of the requested type to be transported to the work stations promptly.

Further features and advantages of the container transport system will be apparent from the exemplary and non-limiting embodiments described below with reference to the drawings.

### BRIEF DESCRIPTION OF THE DRAWINGS

FIG. 1 is a schematic top view of an example container transport system.

FIG. 2 is a diagram of an example travel area.

FIG. 3 is a perspective view of an example transport vehicle.

FIG. 4 is a diagram of the transport vehicle transferring an empty container to a first side in the width direction in an example.

FIG. 5 is a diagram of the transport vehicle transferring an empty container to a second side in the width direction in an example.

FIG. 6 is a block diagram of the container transport system, showing an example system configuration.

FIG. 7 is a perspective view of an example empty container being transported.

FIG. 8 is a perspective view of another example empty container being transported.

FIG. 9 is a schematic top view of another example container transport system.

FIG. 10 is a schematic top view of another example container transport system.

FIG. 11 is a perspective view of another example empty container.

FIG. 12 is a perspective view of the empty container in FIG. 11 with its flaps folded.

### DESCRIPTION OF THE INVENTION

A container transport system according to one or more embodiments will now be described with reference to the drawings. In the present embodiment, a container transport system 100 illustrated includes a work station 4 for picking items based on an order and packing the collected items into a container for shipment. In this system, empty containers 3 for packing the items are supplied to the work station 4. When the picking operation and the packing operation described above are performed at the same work station 4 as in the present embodiment, the picking operation and the packing operation may be collectively referred to as the picking operation. These operations are hereafter collectively referred to as the picking operation unless otherwise specified.

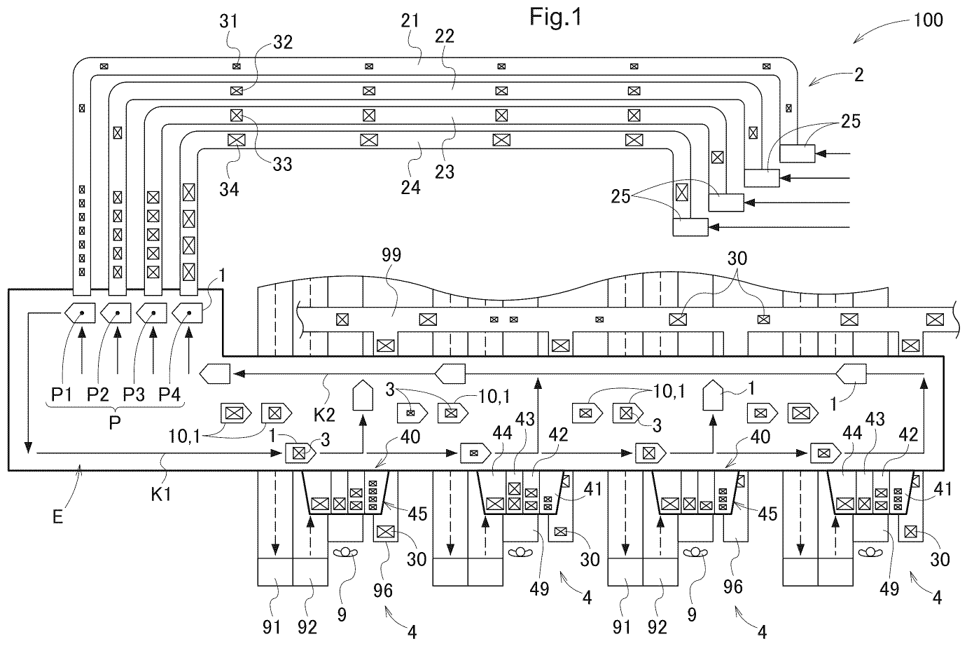

FIG. 1 shows a picking facility mainly including the container transport system 100. In this example, the picking facility includes four work stations 4. As shown in FIG. 1, a single work station 4 includes a single operator 9. Each work station 4 is connected to an article feed conveyor 91 and an article return conveyor 92. The article feed conveyor 91 transports articles (items) from an article storage (not shown) to the work station 4. The article feed conveyor 91 transports, for example, an article container (not shown) containing one or more articles (items) to the work station 4. The operator 9 removes an intended number of articles from the article container and packs the articles into an empty container 3. The article return conveyor 92 transports the article container from which the articles have been removed to the article storage. The processing is repeated for multiple articles based on the order to collect articles based on the order and pack the articles into a container for shipment.

Although both the picking operation of collecting articles to be shipped based on the order and the packing operation of packing the articles to be shipped into a container are performed at the work station 4 in the above example, the packing operation alone may be performed at the work station 4. For example, the article feed conveyor 91 may transport a group of picked articles (or a single article) based on an order to the work station 4, and the operator 9 may pack the group of picked articles into an empty container 3. In this case as well, the article feed conveyor 91 transports the article container containing the group of articles from the article storage to the work station 4, and the article return conveyor 92 (also referred to as an empty container return conveyor in this case) transports the unloaded article container from the work station to the article storage.

Although the operator 9 performs the operation at the work station 4 in the above example, the operation may be performed using, for example, a robot.

The container transport system 100 transports empty containers 3 to the multiple work stations 4 described above. In the present embodiment, a carton container, or more specifically, a cardboard box will be described as an example of the container. The empty container 3 is thus an empty cardboard box. However, the container may be a reusable container box, such as a foldable container box. In this case, the empty container 3 is an empty container box.

In the present embodiment, the empty containers 3 are transported one by one by a transport vehicle 1 that autonomously travels on a flat surface. The transport vehicle 1 receives an empty container 3 from an empty container supplier 2 and transports the empty container 3 to the work station 4. The container transport system 100 includes multiple transport vehicles 1 that travel in a travel area E, the empty container supplier 2 that supplies multiple empty containers 3 of different types selectively to the respective transport vehicles 1, the multiple work stations 4 facing the travel area E and each being a work station in which an operation using the empty container 3 is performed, and a controller 5. The controller 5 may be a single separate controller (computer), or may be a grid computing system in which controllers (computers or microprocessors) included in the transport vehicles 1 and the work stations 4 cooperate with one another.

The controller 5 generates, based on container request information including at least the type of empty container 3 requested by the corresponding work station 4, empty container supply information to supply an empty container 3 to the work station 4. A transport vehicle 1 holding the empty container 3 of the type corresponding to the container request information transports the empty container to the work station 4 corresponding to the container request information based on the empty container supply information.

As described above, an empty cardboard box is an example of the empty container 3 in the present embodiment. In the container transport system 100 according to the present embodiment, as shown in FIG. 1, the empty container supplier 2 includes container formers 25 (carton formers) that form empty containers 3 (empty cardboard boxes) of different types by folding sheet materials (cardboards or corrugated sheets). The empty containers 3 of different types refer to empty containers 3 with different volumes and different bottom areas. The empty containers 3 of different types may also be referred to as, for example, empty containers 3 with different sizes. In the present embodiment, the container formers 25 include four carton formers that form cardboard boxes with different sizes. As schematically shown in FIG. 1, the four carton formers respectively form small containers 31 (first containers), medium containers 32 (second containers), large containers 33 (third containers), and extra-large containers 34 (fourth containers).

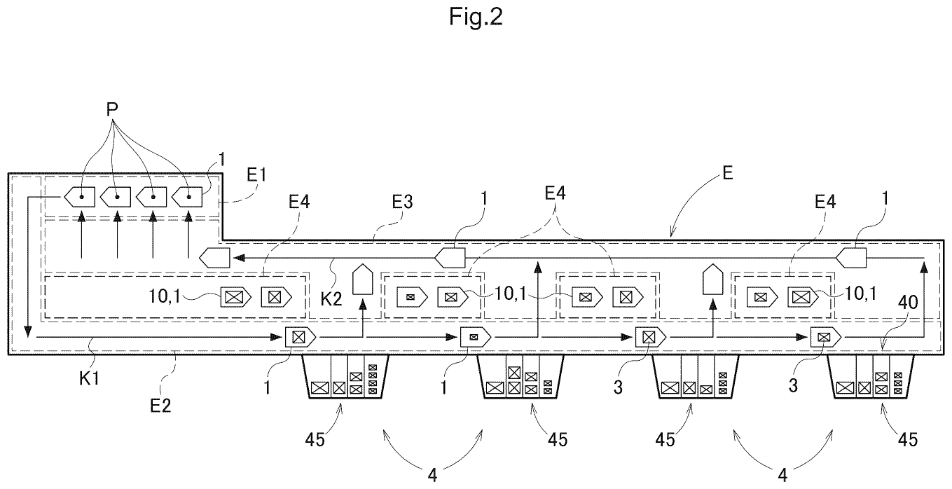

In the present embodiment, conveyors (empty container conveyors) for transporting the formed empty containers 3 are connected to the respective four carton formers. A first container conveyor 21 transports the small containers 31. A second container conveyor 22 transports the medium containers 32. A third container conveyor 23 transports the large containers 33. A fourth container conveyor 24 transports the extra-large containers 34. These empty container conveyors connect the carton formers to the travel area E. The travel area E includes stop positions P at which the transport vehicles 1 stop to receive the empty containers 3 from the empty container conveyors. As shown in FIGS. 1 and 2, a first stop position P1, a second stop position P2, a third stop position P3, and a fourth stop position P4 are defined for the corresponding empty container conveyors. More specifically, the travel area E includes multiple stop positions P at which the transport vehicles 1 stop to receive the empty containers 3 from the empty container supplier 2 (the container formers 25 and the empty container conveyors). The stop positions P are each defined for a different type of empty containers 3.

The area including these stop positions P in the travel area E is an empty container receiving area E1 in which the transport vehicles 1 receive the empty containers 3. Thus, the empty container conveyors connect the container formers 25 (carton formers) to the empty container receiving area E1 in the travel area E and supply the empty containers 3 to the empty container receiving area E1. In other words, the stop positions P in the empty container receiving area E1 are receiving positions at which the transport vehicles 1 receive the empty containers 3. More specifically, the first stop position P1 is a first receiving position for receiving the small containers 31 from the first container conveyor 21, the second stop position P2 is a second receiving position for receiving the medium containers 32 from the second container conveyor 22, the third stop position P3 is a third receiving position for receiving the large containers 33 from the third container conveyor 23, and the fourth stop position P4 is a fourth receiving position for receiving the extra-large containers 34 from the fourth container conveyor 24.

Although not shown, the first container conveyor 21, the second container conveyor 22, the third container conveyor 23, and the fourth container conveyor 24 may, for example, merge into a single container conveyor downstream. In this case, the travel area E may include a shared stop position P at which the transport vehicles 1 receive the empty containers 3 of all the types.

For example, the conveyors may be arranged separately for areas for receiving the empty containers 3 of different types from the container formers 25, and may immediately merge into a single container conveyor to transport the empty containers 3 of different types. For a single container former 25 that can form empty containers 3 of different types, the system may include the single container former 25 and a single container conveyor that connects the single container former 25 and a single stop position P.

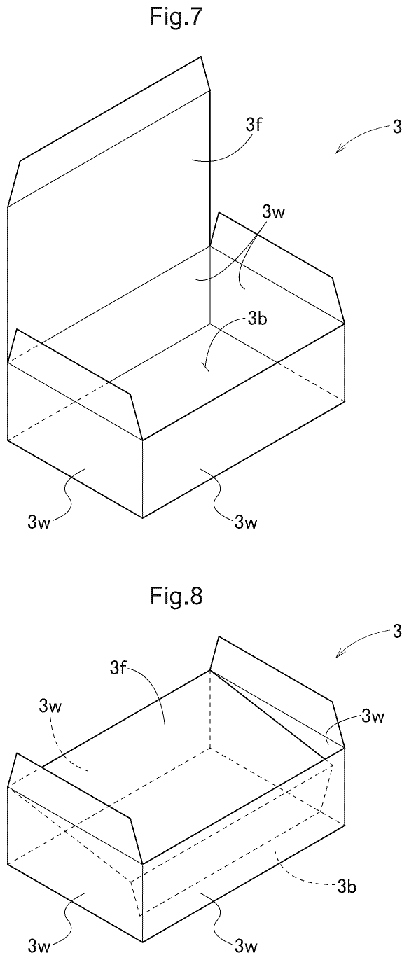

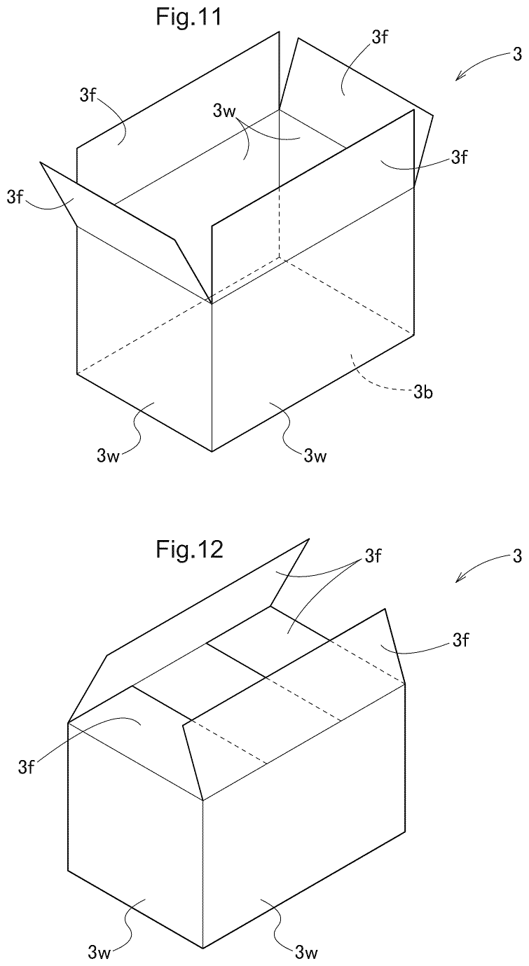

The carton former forms, for example, an empty container 3 as shown in FIGS. 7 and 11. The empty container 3 has a bottom surface 3b, side walls W extending upward from the outer edges of the bottom surface 3b, and a flap(s) 3f extending from a side wall(s) 3w. The flap(s) 3f is foldable parallel to the bottom surface 3b (slightly tiltable at about 5 degrees) to be a lid on the upper surface of the empty container 3. Although the bottom surface 3b (and the flap(s) 3f) is rectangular in this example, the shape may be, for example, a square, an octagon, or a hexagon.

The empty container 3 shown in FIG. 7 has the flap 3f unfolded and extending vertically along one side wall 3w (in a flap-unfolded state described later). The empty container 3 shown in FIG. 11 has four flaps 3f unfolded and extending vertically along the respective four side walls 3w (in the flap-unfolded state). These four flaps 3f include two pairs of opposing flaps 3f that are congruent (with the same shape and the same area). In the flap-unfolded state, the flaps 3f may tilt inward when the flaps 3f are not folded to cover the opening of the empty container 3.

However, the empty container 3 with the flap(s) 3f unfolded as shown in FIGS. 7 and 11 uses a larger space and thus has the center of gravity at a higher level than an empty container 3 with the flap(s) 3f folded to form a box. When traveling in the travel area E, the transport vehicle 1 carrying the empty container 3 is likely to receive air resistance, increasing the likelihood that the empty container 3 falls over on the transport vehicle 1 or drops off the transport vehicle 1.

The carton former can thus form the empty container 3 in a flap-folded state in which the flap(s) 3f is folded inward to be in contact with the inner surfaces of the side walls 3w as shown in FIG. 8. Although the flap(s) 3f is folded downward through the opening in FIG. 8, the flap(s) 3f may not be folded downward and may be folded onto the ends of the side walls 3w adjacent to the opening as shown in FIG. 12. For the empty container 3 including two pairs of flaps 3f with each pair of flaps 3f being congruent as shown in FIGS. 11 and 12, the flap-folded state may refer to the state in which either pair of flaps 3f are folded. All the flaps 3f (two pairs of flaps 3f) may also be folded.

However, when the empty container 3 is supplied to the work station 4 with the flap(s) folded, the operator 9 first opens the flap(s) 3f to pack articles. When the empty container 3 is supplied to the work station 4 with the lid being open, the operator 9 can readily pack the articles into the supplied empty container 3. Thus, some of the empty containers 3 of different types may be transported in the flap-folded state.

As described above, the empty containers 3 of different types include the small containers 31, the medium containers 32, the large containers 33, and the extra-large containers 34. As the empty container 3 is larger, the flap 3f is larger. For example, the large container 33 and the extra-large container 34, or the extra-large container 34 alone may be formed and transported in the flap-folded state, whereas the empty containers 3 of the other types may be transported with the flap(s) 3f unfolded and extending upward. More specifically, the container former 25 may supply, among the empty containers 3 of different types, an empty container 3 sized larger than or equal to a predetermined size (e.g., large or extra-large) to the transport vehicle 1 in the flap-folded state, and supply an empty container 3 sized smaller than the predetermined size to the transport vehicle 1 with the flap(s) 3f unfolded and extending upward (in the flap-unfolded state).

In the present embodiment, the container formers 25 supply the empty containers 3 to the transport vehicles 1 with the empty container conveyors. However, the container formers 25 may be arranged adjacent to the travel area E to directly supply the empty containers 3 to the empty container receiving area E1 in the travel area E. The empty containers 3 are transferred from the terminal ends (the ends adjacent to the travel area E) of the empty container conveyors to the transport vehicles 1 or from the container formers 25 without the empty container conveyors to the transport vehicles 1 by operators or robots different from the operators 9 working at the work stations 4. All the empty containers 3 may also be supplied to the transport vehicles 1 in the flap-folded state or in the flap-unfolded state.

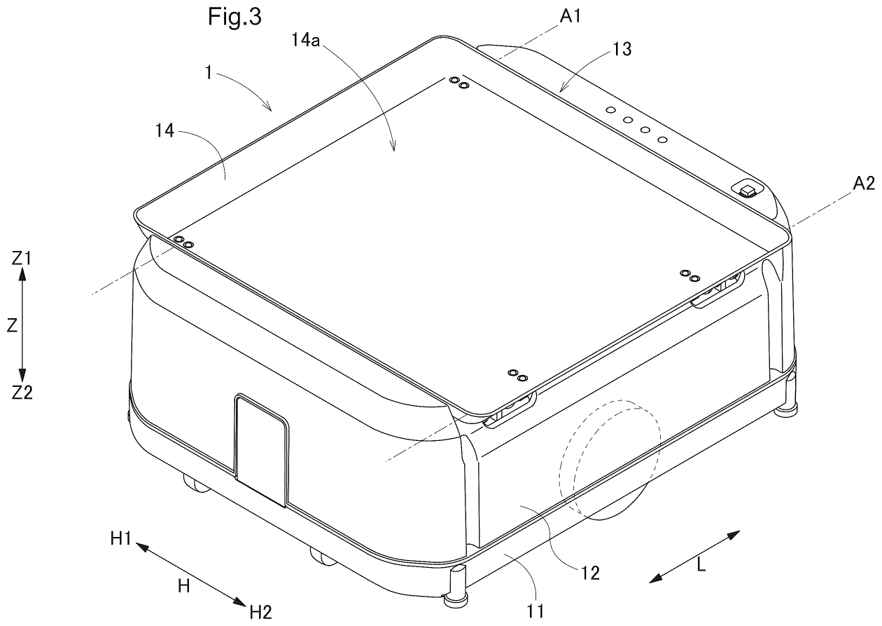

FIG. 3 is a perspective view of the transport vehicle 1 transporting the empty container 3 in an example. Although the traveling direction of the transport vehicle 1 is defined in one direction in FIGS. 1 and 2 to indicate the direction in which the transport vehicle 1 travels forward, the transport vehicle 1 can travel forward or backward at the same speed. For example, after traveling forward on a dead-end path, the transport vehicle 1 can travel backward in the opposite direction without turning.

As shown in FIG. 3, the transport vehicle 1 for transporting the empty container 3 includes a vehicle body including a body frame 11 and a body cover 12, and a transfer device 13 (transferrer) mounted on the vehicle body. The transport vehicle 1 also includes a wheel drive source (not shown) for driving wheels, such as a motor. The motor is powered by a power storage (not shown) mounted on the transport vehicle 1, such as a battery. The transfer device 13 includes a mount 14 including a mount surface 14a on which an article such as the empty container 3 is placeable, and a transfer drive that drives the mount 14.

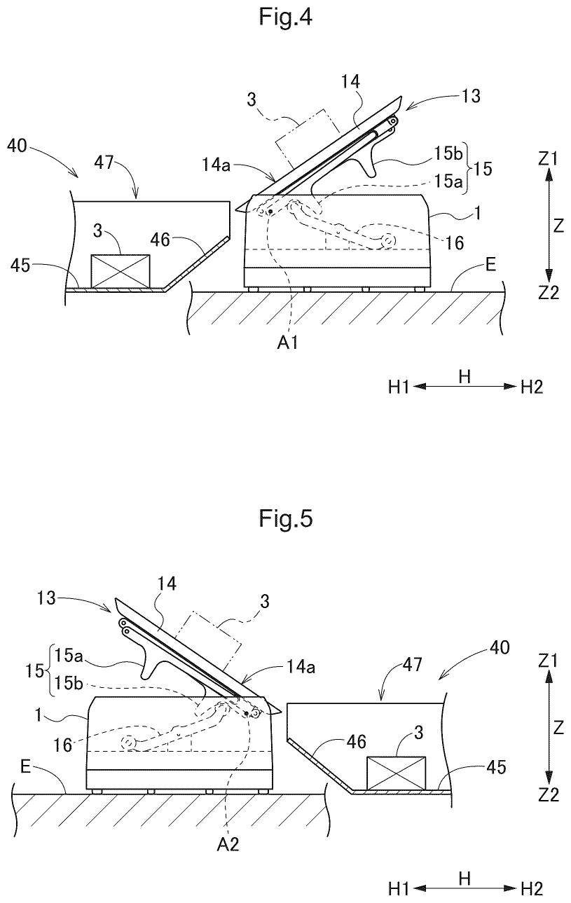

The mount 14 is in the form of a tray with the edges of the mount surface 14a in the form of a plate sloping upward. An article such as the empty container 3 is placeable on the mount surface 14a. The mount 14 is swingable about a swing shaft (a first swing shaft A1 or a second swing shaft A2) relative to the vehicle body. The first swing shaft A1 and the second swing shaft A2 are parallel to each other. A direction along the first swing shaft A1 and the second swing shaft A2 is referred to as an axial direction L. The mount 14 is driven by the transfer drive to swing between a reference orientation (refer to FIG. 3) in which the mount 14 is aligned with a travel surface on which the transport vehicle 1 travels (a horizontal surface when the transport vehicle 1 travels on the horizontal surface) and a raised orientation (refer to FIGS. 4 and 5) in which the mount tilts relative to the travel surface. As shown in FIGS. 4 and 5, the transfer device 13 slides the empty container 3 on the mount 14 in a body width direction H by tilting the mount 14 in the body width direction H, and transfers the empty container 3 to a transfer area (a receiver 40 at the work station 4) disposed outward in the body width direction H relative to the transport vehicle 1.

The transfer device 13 can swing the mount 14 about the first swing shaft A1 (refer to FIG. 4) relative to the vehicle body, and also about the second swing shaft A2 (refer to FIG. 5). More specifically, the transport vehicle 1 can transfer, by swinging the mount 14, an article such as the empty container 3 to a position on a first side H1 in the body width direction or to a position on a second side H2 in the body width direction.

A swing arm 15 extends in the body width direction H and swings between the reference orientation in which the swing arm 15 is aligned with the horizontal surface and the raised orientation in which the swing arm 15 tilts relative to the horizontal surface (refer to FIGS. 4 and 5). The mount 14 is in a horizontal orientation in which the mount surface 14a is aligned with the horizontal surface with the swing arm 15 in the reference orientation. When switching from the horizontal orientation to the raised orientation as shown in, for example, FIGS. 4 and 5, the swing arm 15 presses the mount surface 14a from a lower side Z2, swinging the mount 14. In response to the swing arm 15 being in the raised orientation, the mount 14 is placed in a tilting orientation in which the mount surface 14a tilts relative to the swing arm 15.

The swing arm 15 includes a first swing arm 15a and a second swing arm 15b. When switching from the horizontal orientation to the raised orientation, the first swing arm 15a presses the mount 14 from the lower side Z2, swinging the mount 14 about the first swing shaft A1. The mount 14 is thus displaced toward an upper side Z1 on the side opposite the first swing shaft A1 (the second side H2 in the body width direction). In response to the first swing arm 15a being in the raised orientation, the mount 14 is placed in the tilting orientation (first tilting orientation; refer to FIG. 4) in which the mount surface 14a tilts relative to the horizontal surface. In the first tilting orientation, the mount surface 14a tilts to face the first side H1 in the body width direction. When switching from the horizontal orientation to the raised orientation, the second swing arm 15b presses the mount 14 from the lower side Z2, swinging the mount 14 about the second swing shaft A2. The mount 14 is thus displaced toward the upper side Z1 on the side opposite the second swing shaft A2 (the first side H1 in the body width direction). In response to the second swing arm 15b being in the raised orientation, the mount 14 is placed in the tilting orientation (second tilting orientation; refer to FIG. 5) in which the mount surface 14a tilts relative to the horizontal surface. In the second tilting orientation, the mount surface 14a tilts to face the second side H2 in the body width direction.

Each work station 4 includes the receiver 40 that receives an empty container 3 from a transport vehicle 1 in the travel area E. The receiver 40 includes a chute 47 with a sloping guide surface 46 and a container holding conveyor 45. As described above, the transport vehicle 1 includes the transfer device 13 (transferrer) for transferring the empty container 3 being held to the receiver 40. The empty container 3 slid off the mount 14 in the tilting orientation slides on the guide surface 46 sloping at an angle similar to the tilt angle of the mount 14 and reaches the container holding conveyor 45 to be held with it.

As shown in FIGS. 1 and 2, the container holding conveyor 45 in the present embodiment includes a first conveyor 41, a second conveyor 42, a third conveyor 43, and a fourth conveyor 44 that each hold the corresponding empty containers 3 of different types. The first conveyor 41, the second conveyor 42, the third conveyor 43, the fourth conveyor 44, and the container holding conveyors 45 collectively referring these conveyors correspond to holders that each hold the corresponding empty containers 3 of different types. The container holding conveyors 45 may be conveyor belts or roller conveyors including drive sources, or gravity roller conveyors including no drive source. The holders may be mounts in the form of plates rather than conveyors.

Although the transport vehicle 1 includes the transfer device 13 and the work station 4 includes the receiver 40 in the present embodiment, the container transport system 100 may not include the transfer device 13 or the receiver 40. For example, the transport vehicle 1 without the transfer device 13 may receive an empty container 3 and transport the empty container 3 to the work station 4, and the operator 9 may move the empty container 3 from the transport vehicle 1 to the holder for the empty container 3 at the work station 4. In place of the operator 9, a transfer robot may move the empty container 3 from the transport vehicle 1 to the holder.

The holders for the empty containers 3, such as the first conveyor 41, the second conveyor 42, the third conveyor 43, and the fourth conveyor 44 described above, serve as buffers to hold the empty containers 3. Such buffers may not be arranged for the empty containers 3 of all types. A single buffer may be used for the empty containers 3 of the type used most frequently. In any cases, each work station 4 includes the buffer(s) for the empty containers 3 to allow continuous operations.

A single holder or multiple holders may include a sensor(s) (not shown) for detecting the remaining number of empty containers 3 being held. Examples of the sensor include a proximity sensor installed at a specific position of the holder to detect the presence of the empty containers 3 and an image sensor that identifies the empty containers 3 in a captured image. Each work station 4 may output, in response to the remaining number of empty containers 3 of each type held by the corresponding holder being less than or equal to a predetermined set value, the container request information including the type of empty container 3. For the work station 4 including a single holder, the work station 4 outputs the container request information in response to the remaining number of empty containers 3 held by the single holder being less than or equal to the set value. The set value is an integer greater than or equal to 0 or a natural number, and may be changeable by the operator 9. The set value may be different for each type of empty container 3.

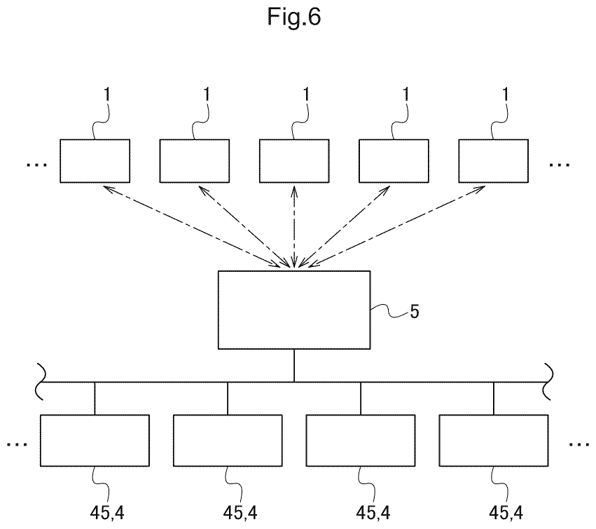

FIG. 6 is a block diagram of the container transport system 100, showing an example system configuration. As described above, the controller 5 may be a single separate controller (computer), or may be a grid computing system in which the controllers (computers or microprocessors) included in the transport vehicles 1 and the work stations 4 operate in cooperation with one another. For ease of explanation, FIG. 6 shows, as the controller 5, a controller that centrally controls the entire container transport system 100. Although the controller 5 and the transport vehicles 1 communicate wirelessly and the controller 5 and the work stations 4 communicate with a wire in the example shown in FIG. 6, the controller 5 and the work stations 4 may also communicate wirelessly. Although not shown, the transport vehicles 1 may also wirelessly communicate with oner another.

The controller in each work station 4 outputs the container request information in response to determining that the remaining number of empty containers 3 being less than or equal to the set value based on the detection results from the sensors included in the holders (e.g., the container holding conveyors 45). For a holder including no sensor, for example, the controller in the work station 4 may output the container request information based on the operation on, for example, a container request switch performed by the operator 9.

The controller 5 generates and outputs, based on the container request information from each work station 4, the empty container supply information for supplying the empty containers 3 to the respective work stations 4. The empty container supply information may be output to a designated transport vehicle 1 or may be output without designating a transport vehicle 1. The designated transport vehicle 1 may be a transport vehicle 1 carrying an empty container 3 of the requested type or a transport vehicle 1 carrying no empty container 3. When a transport vehicle 1 carrying an empty container 3 of the requested type is designated, the designated transport vehicle 1 transports the empty container 3 to the corresponding work station 4. When the designated transport vehicle 1 carries no empty container 3, the designated transport vehicle 1 receives an empty container 3 of the requested type from the empty container supplier 2 and transports the received empty container 3 to the corresponding work station 4. When the controller 5 designates a transport vehicle 1 in this manner, each transport vehicle 1 may transmit, to the controller 5, information indicating whether the transport vehicle 1 carries an empty container 3, together with information indicating the type of the empty container 3 carried on the transport vehicle 1.

When no transport vehicle 1 is designated, a transport vehicle 1 transporting an empty container 3 of the type requested based on the empty container supply information responds to the request based on the empty container supply information. When a transport vehicle 1 carrying an empty container 3 of the requested type is available, the transport vehicle 1 may respond to the request. The response may be transmitted to the controller 5 and all other transport vehicles 1. Based on this response, the other transport vehicles 1 do not transport an empty container 3 requested based on the empty container supply information. The responding transport vehicle 1 transports the empty container 3 to the corresponding work station 4. When no transport vehicle 1 carrying an empty container 3 of the requested type is available, a single transport vehicle 1 carrying no empty container 3 responds to the request. Similarly, the response may be transmitted to the controller 5 and all other transport vehicles 1. Based on this response, the other transport vehicles 1 may not transport the empty container 3 based on the empty container supply information. The responding transport vehicle 1 receives the requested empty container 3 from the empty container supplier 2 and transports the requested empty container 3 to the corresponding work station 4.

In the above example, a transport vehicle 1 carrying an empty container 3 and a transport vehicle 1 carrying no empty container 3 are available. More specifically, in the container transport system 100, the multiple transport vehicles 1 may include at least one standby transport vehicle 10 that waits while holding an empty container 3 (refer to FIGS. 1 and 2), independently of the empty container supply information. More specifically, at least one of the multiple transport vehicles 1 is the standby transport vehicle 10 holding an empty container 3 with its destination work station 4 unspecified.

For the container transport system 100 in which the empty containers 3 of four types are transported as in the present embodiment, the container transport system 100 may include at least four standby transport vehicles 10 that wait while holding the empty containers 3 of different types. Multiple standby transport vehicles 10 may also hold the empty containers 3 of the same type. More specifically, in the container transport system 100, each of the empty containers 3 of all different types may be held by at least one standby transport vehicle 10.

The structure is not limited to this example. For the container transport system 100 in which the empty containers 3 of different types are transported, a specific empty container of a specific type among the empty containers 3 of different types may be held by at least one standby transport vehicle 10. The empty container of the specific type may be, for example, an empty container 3 that is used most frequently or a largest empty container 3 that is stored fewest in the holder for the empty containers 3.

Although the standby transport vehicles 10 are available in the present embodiment, the standby transport vehicles 10 may be eliminated. After the empty container supply information is transmitted, all the transport vehicles 1 may each receive an empty container 3 from the empty container supplier 2 and transport the empty container 3 to the corresponding work station 4. Conversely, all transport vehicles 1 except the transport vehicles 1 transporting the empty containers 3 to the corresponding work stations 4 and the transport vehicles 1 traveling toward the empty container supplier 2 to receive the empty containers 3 (including transport vehicles 1 transferring the empty containers 3 to the corresponding work stations 4 and unloaded transport vehicles 1 after transferring) may serve as the standby transport vehicles 10.

For the container transport system 100 including the standby transport vehicles 10 as in the present embodiment, the standby transport vehicles 10 transport the empty containers 3 with priority over the other transport vehicles 1. More specifically, when a standby transport vehicle 10 carrying an empty container 3 of the type requested by the corresponding work station 4 is available, the standby transport vehicle 10 transports the empty container 3 to the work station 4. When no such a standby transport vehicle 10 is available, another transport vehicle 1 receives the corresponding empty container 3 from the empty container supplier 2 and transports the empty container 3 to the work station 4.

As shown in FIG. 2, the travel area E includes the empty container receiving area E1, an empty container transport area E2, a return area E3, and a standby area E4. The empty container receiving area E1 includes the stop positions P at which the transport vehicles stop to receive the empty containers 3 from the empty container supplier 2. The empty container transport area E2 is an area in which the transport vehicles 1 carrying the empty containers 3 travel along an area including the multiple work stations 4 arranged adjacent to one another. The return area E3 includes the return path along which unloaded transport vehicles 1 after transferring the empty containers 3 to the corresponding work stations 4 travel toward the empty container supplier 2. The standby area E4 is an area in which the standby transport vehicles 10 wait, or more specifically, an area in which the transport vehicles 1 carrying the empty containers 3 are parked as the standby transport vehicles 10. The empty container receiving area E1, the empty container transport area E2, the return area E3, and the standby area E4 have no overlap between one another in the travel area E.

As described above, one or more articles to be shipped are packed into an empty container 3 at each work station 4. As shown in FIG. 1, each work station 4 includes a feed conveyor 96 connected to a shipment conveyor 99. The operator 9 places a shipment container 30 containing articles to be shipped onto the feed conveyor 96. The feed conveyors 96 arranged at the respective work stations 4 merge into the shipment conveyor 99 shared by the feed conveyors 96. The shared shipment conveyor 99 transports shipment containers 30 from the respective work stations 4. The shipment conveyor 99 transports the shipment containers 30 to, for example, a shipping terminal (not shown) or a shipping station (not shown) including a truck berth or other places, at which a process is performed following the operation at the work station.

In the above example, each transport vehicle 1 transports an empty container 3 alone as described above. However, the transport vehicle 1 may further transport, in addition to the empty container 3, the shipment container 30 that is a container in which the articles to be shipped are packed at the work station 4. More specifically, the transport vehicle 1 transports, in response to a shipment transport command from the controller 5, the shipment container 30 to a predetermined destination. For example, the operator 9 transmits a shipment transport request to the controller 5 by operating a switch (including a touchscreen) indicating completion of a packing operation at the work station 4. The controller 5 then transmits a shipment transport command to the transport vehicle 1. In the same manner as for the empty container supply information, the controller 5 may designate a transport vehicle 1 and transmit a shipment transport command to the designated transport vehicle 1, or may transmit a shipment transport command without designating a transport vehicle 1. The transport vehicle 1 transports the shipment container 30 to the shipment terminal or the shipment station described above, or to the shipment conveyor 99 that does not extend to the work stations 4.

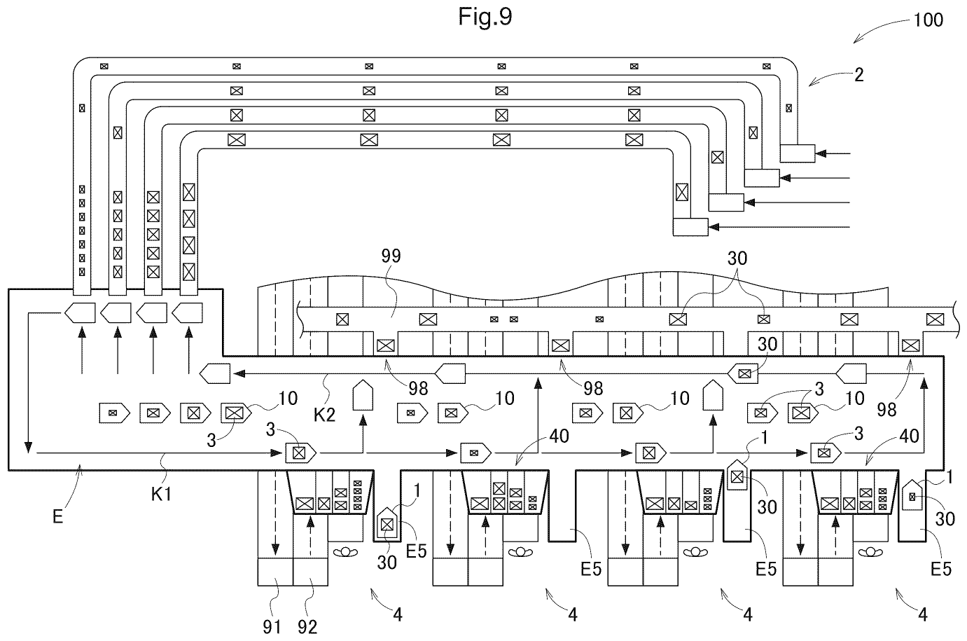

In the example illustrated in FIG. 9, the travel area E further includes feed areas E5. Each feed area E5 branches from the empty container transport area E2 and extends toward the corresponding work station 4. The transport vehicles 1 carrying the shipment containers 30 travel from the feed area E5 through the empty container transport area E2 to the return area E3, and transfers the shipment container 30 from the return area E3 to the shipment conveyor 99 adjacent to the return area E3. The shipment conveyor 99 thus includes unloaders 98 for transferring the shipment containers 30 from the transport vehicles 1 to the shipment conveyor 99. Each unloader 98 may transfer the shipment containers 30 with the same structure as for transferring the empty containers 3 from the transport vehicles 1 to the chute 47 at the work station 4, and will not be described in detail.

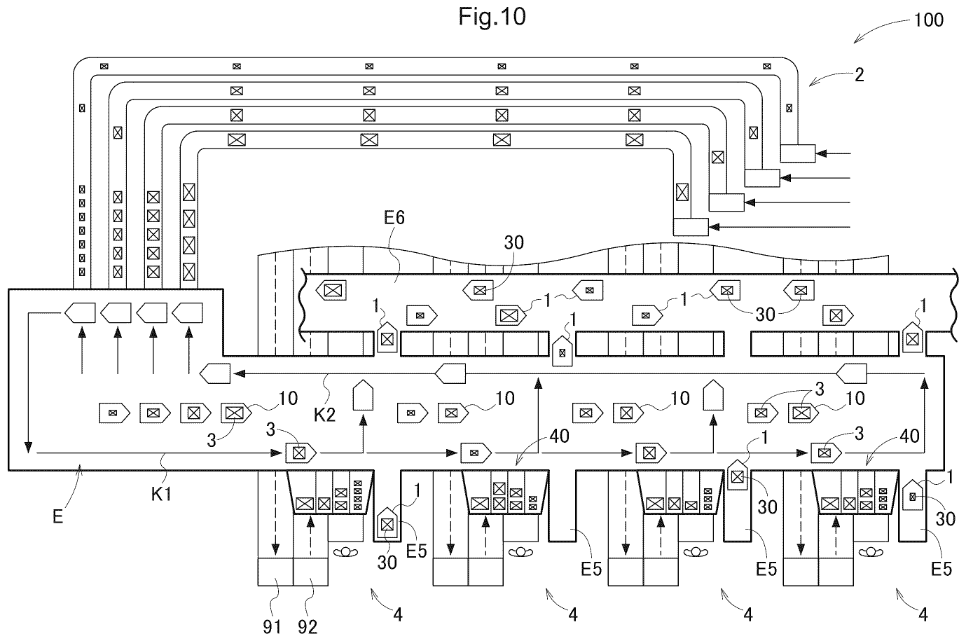

In the example illustrated in FIG. 10, the travel area E further includes, in addition to the feed areas E5, a shipment travel area E6. In this example, the transport vehicles 1 carrying the shipment containers 30 travel in the shipment travel area E6 without using the shipment conveyor 99, and transports the shipment containers 30 to, for example, a shipping terminal or a shipping station, at which a process is performed following the operation at the work station.

An overview of the container transport system described above is briefly provided below.

In one aspect, a container transport system includes a plurality of transport vehicles that travel in a travel area, an empty container supplier that supplies a plurality of empty containers of different types selectively to the respective plurality of transport vehicles, a plurality of work stations facing the travel area and being a work station in which an operation using an empty container is performed, and a controller that generates, based on container request information including at least a type of empty container to be used at each of the plurality of work stations, empty container supply information to supply an empty container to each of the plurality of work stations. Each of the plurality of transport vehicles holds the empty container of the type corresponding to the container request information and transports the empty container to the work station corresponding to the container request information based on the empty container supply information.

In this structure, multiple transport vehicles traveling in the travel area transport empty containers, achieving higher flexibility in selecting the transport path for the empty containers than when the empty containers are transported by, for example, a conveyor. This structure can thus reduce unequal transport time of empty containers to the respective work stations resulting from the arrangement of the multiple work stations, and allows the empty containers of the requested type to be transported to the work stations promptly.

In the container transport system, the plurality of transport vehicles may include at least one standby transport vehicle that waits while holding the empty container, independently of the empty container supply information. The travel area may include a standby area in which the at least one standby transport vehicle waits. The at least one standby transport vehicle may transport the empty container with priority over another of the plurality of transport vehicles.

This structure allows at least one of the multiple transport vehicles holding the empty container to wait in the travel area as a standby transport vehicle. Thus, the time taken for the requested empty container to reach the work station is likely to be shorter than when the transport vehicle receives the container from the empty container supplier based on the container supply information and transports the container to the work station.

In the container transport system, the at least one standby transport vehicle may hold a specific empty container of a specific type among the plurality of empty containers of different types.

In this structure, empty containers in high demand or empty containers that are not easily stored in large numbers at the work stations may be specified as the specific empty containers. The structure can easily reduce the shortage of such empty containers at the work stations.

In the container transport system, each of the plurality of empty containers of different types may be held by at least one standby transport vehicle.

This structure allows the empty containers of any type requested by the work station to be delivered promptly to the work station.

In the container transport system, each of the plurality of work stations may include a receiver that receives an empty container from a transport vehicle among the plurality of transport vehicles in the travel area. Each of the plurality of transport vehicles may include a transferrer that transfers the empty container being held to the receiver.

This structure allows the empty container to be transferred to and from the work station without involving an operator or a robot operating as a main member of the operation at the work station. This can easily reduce the number of work-hours for the operator or the robot at the work station.

In the container transport system, the receiver may include a plurality of holders that each hold a corresponding empty container of the plurality of empty containers of different types. Each of the plurality of work stations may output, in response to a remaining number of empty containers of a type of the different types held by a corresponding holder of the plurality of holders being less than or equal to a predetermined set value, the container request information including the type of empty container.

This structure allows each work station to appropriately output the container request information based on the use state of the empty containers at each work station. Thus, each work station can easily receive supply of the containers of the requested type.

In the container transport system, the travel area may include a plurality of stop positions at which the plurality of transport vehicles stop to receive the plurality of empty containers from the empty container supplier. The plurality of stop positions may each be defined for a different type of empty container.

This structure allows the multiple transport vehicles to simultaneously receive the empty containers of different types, allowing the empty containers requested by the work station to be transported promptly.

In the container transport system, in each of the plurality of work stations, an article to be shipped may be packed in the empty container. Each of the plurality of transport vehicle may transport, in response to a shipment transport command from the controller, a shipment container being a container in which the article to be shipped is packed to a predetermined destination.

This structure allows transportation of shipment containers, in addition to the empty containers, using the transport vehicles. This structure can thus easily increase the operating rate of the transport vehicles and reduce involvement of transporters such as a conveyor for transporting the shipment containers.

In the container transport system, the empty container supplier may include a container former that forms the plurality of empty containers of different types by bending a sheet material. Each of the plurality of empty containers may have a bottom surface, side walls extending upward from outer edges of the bottom surface, and a flap extending from at least one of the side walls and foldable parallel to the bottom surface to be a lid on an upper surface of the empty container. The container former may supply, to the plurality of transport vehicles, the plurality of empty containers each with the flap folded inward to be in contact with inner surfaces of the side walls.

In this structure, each empty container including the flap folded inward can increase the rigidity of the empty container and reduce air resistance during transportation. Thus, empty containers formed from a lightweight material can be transported stably by the transport vehicles.

In the container transport system, the empty container supplier may include a container former that forms the plurality of empty containers of different types by bending a sheet material. Each of the plurality of empty container may have a bottom surface, side walls extending upward from outer edges of the bottom surface, and a flap extending from at least one of the side walls and foldable parallel to the bottom surface to be a lid on an upper surface of the empty container. The plurality of empty containers of different types may include empty containers with different sizes. The container former may supply, among the plurality empty containers of different types, an empty container sized larger than or equal to a predefined size to the plurality of transport vehicles with the flap folded inward to be in contact with inner surfaces of the side walls. The container former may supply, among the plurality empty containers of different types, an empty container sized smaller than the predetermined size to the plurality of transport vehicles with the flap unfolded and extending upward.

A relatively large empty container is likely to receive higher air resistance during transportation. In the above structure, such an empty container sized larger than or equal to a predetermined size is supplied to the transport vehicles with the flap being folded, thus allowing the transport vehicles to transport the empty container stably. In contrast, an empty container sized smaller than the predetermined size is supplied to the transport vehicles with the flap unfolded and extending upward. The operator can thus perform an operation without opening the flap. This simplifies the operation in the work area.

In the container transport system, the travel area may include an empty container receiving area including a stop position at which a transport vehicle of the plurality of transport vehicles stops to receive an empty container from the empty container supplier, an empty container transport area defined along an area in which the plurality of work stations are arranged and including an empty container transport path along which the plurality of transport vehicles travel, and a return area including a return path along which the plurality of transport vehicles that have transferred empty containers to the plurality of work stations travel toward the empty container supplier. The empty container receiving area, the empty container transport area, and the return area may have no overlap between one another. The standby area in the travel area may have no overlap with the empty container receiving area, the empty container transport area, and the return area.

The empty container receiving area, the empty container transport area, and the return area are areas in which the transport vehicles travel frequently in the travel area. In the standby area, the transport vehicles are parked for a long time. In the above structure, the standby area has no overlap with the empty container receiving area, the empty container transport area, and the return area. This allows the standby transport vehicles to wait at positions less likely to interfere with the other traveling transport vehicles, allowing efficient supply of the empty containers to the work stations and efficient traveling of the transport vehicles.

What is claimed is:

1. A container transport system, comprising:
a plurality of transport vehicles configured to travel in a travel area;
an empty container supplier configured to supply a plurality of empty containers of different types selectively to the respective plurality of transport vehicles;
a plurality of work stations facing the travel area, each of the plurality of work stations comprising a work station in which an operation using an empty container is performed; and
a controller configured to generate, based on container request information comprising at least a type of empty container to be used at each of the plurality of work stations, empty container supply information to supply an empty container to each of the plurality of work stations, and
wherein each of the plurality of transport vehicles is configured to hold the empty container of the type corresponding to the container request information and transport the empty container to the work station corresponding to the container request information based on the empty container supply information.

2. The container transport system according to claim 1, wherein:
the plurality of transport vehicles comprise at least one standby transport vehicle configured to wait while holding the empty container, independently of the empty container supply information,
the travel area comprises a standby area in which the at least one standby transport vehicle waits, and
the at least one standby transport vehicle transports the empty container with priority over another of the plurality of transport vehicles.

3. The container transport system according to claim 2, wherein:
the at least one standby transport vehicle holds a specific empty container of a specific type among the plurality of empty containers of different types.

4. The container transport system according to claim 2, wherein:
each of the plurality of empty containers of different types is held by at least one standby transport vehicle.

5. The container transport system according to claim 1, wherein:
each of the plurality of work stations comprises a receiver configured to receive an empty container from a transport vehicle among the plurality of transport vehicles in the travel area, and
each of the plurality of transport vehicles comprises a transferrer configured to transfer the empty container being held to the receiver.

6. The container transport system according to claim 5, wherein:
the receiver comprises a plurality of holders each configured to hold a corresponding empty container of the plurality of empty containers of different types, and
each of the plurality of work stations outputs, in response to a remaining number of empty containers of a type of the different types held by a corresponding holder of the plurality of holders being less than or equal to a predetermined set value, the container request information comprising the type of empty container.

7. The container transport system according to claim 1, wherein:
the travel area comprises a plurality of stop positions at which the plurality of transport vehicles stop to receive the plurality of empty containers from the empty container supplier, and the plurality of stop positions are each defined for a different type of empty container.

8. The container transport system according to claim 1, wherein:
in each of the plurality of work stations, an article to be shipped is packed in the empty container, and
each of the plurality of transport vehicle transports, in response to a shipment transport command from the controller, a shipment container to a predetermined destination, and the shipment container is a container in which the article to be shipped is packed.

9. The container transport system according to claim 1, wherein:
the empty container supplier comprises a container former configured to form the plurality of empty containers of different types by bending a sheet material,
each of the plurality of empty containers has a bottom surface, side walls extending upward from outer edges of the bottom surface, and a flap extending from at least one of the side walls and foldable parallel to the bottom surface to be a lid on an upper surface of the empty container, and
the container former supplies, to the plurality of transport vehicles, the plurality of empty containers each with the flap folded inward to be in contact with inner surfaces of the side walls.

10. The container transport system according to claim 1, wherein:
the empty container supplier comprises a container former configured to form the plurality of empty containers of different types by bending a sheet material,
each of the plurality of empty container has a bottom surface, side walls extending upward from outer edges of the bottom surface, and a flap extending from at least one of the side walls and foldable parallel to the bottom surface to be a lid on an upper surface of the empty container,
the plurality of empty containers of different types comprise empty containers with different sizes,
the container former supplies, among the plurality empty containers of different types, an empty container sized larger than or equal to a predefined size to the plurality of transport vehicles with the flap folded inward to be in contact with inner surfaces of the side walls, and
the container former supplies, among the plurality empty containers of different types, an empty container sized smaller than the predetermined size to the plurality of transport vehicles with the flap unfolded and extending upward.

11. The container transport system according to claim 2, wherein:
the travel area comprises:
an empty container receiving area comprising a stop position at which a transport vehicle of the plurality of transport vehicles stops to receive an empty container from the empty container supplier,
an empty container transport area defined along an area in which the plurality of work stations are arranged, the empty container transport area comprising an empty container transport path along which the plurality of transport vehicles travel, and
a return area comprising a return path along which the plurality of transport vehicles that have transferred empty containers to the plurality of work stations travel toward the empty container supplier,
the empty container receiving area, the empty container transport area, and the return area have no overlap between one another, and
the standby area in the travel area has no overlap with the empty container receiving area, the empty container transport area, and the return area.
